(19) United States
(12) Patent Application Publication
(10) Pub. No.: US 2011/0140893 A1
(43) Pub. Date: Jun. 16, 2011

(54) SMART MOTION DETECTOR FOR ELECTRONIC FENCE

(76) Inventor: BENI MAGAL, Kiryat Ata (IL)

(21) Appl. No.: 12/639,408

(22) Filed: Dec. 16, 2009

(51) Int. Cl. G08B 13/00

(52) U.S. Cl. 340/550

(57) ABSTRACT

The present invention relates to a smart motion detector for electronic fence the type of the fence is a wire strings fence that stretched horizontally between two poles and in the middle of those poles there is a detectors pole which contains the motion detectors, the motion detector is construct on a moving system and uses gyro sensor technology to detect motion on its attaches string wire.

### FIELD OF THE INVENTION

The present invention relates to smart motion detector for electronic fence.

The type of the fence is a wire strings fence that stretched horizontally between two poles and in the middle of those poles there is a detectors pole which contains the motion detectors, those detectors are attach to the wire strings and have the ability to detect motion on those strings and to give a report on it.

This report is send to the fence control system that analyzes and presents them to the user.

### BACKGROUND OF THE INVENTION

Other objects and advantages of the invention will become apparent as the description proceeds.

Usually electronic fence need to be very sensitive to movement on the wire strings to detect an act of penetration to the safe area.

The fence detector that attaches to the string wire need to be very reliable to detect a breach on the fence with minimum of detector failures that reflects with false alarms or threats not detected.

The object of the present invention is a new type of movement detector which detects motion on its attaches string wire and sends a report to the control center.

The new detector uses the technology of gyro sensor to sense when motion occurs on its attaches fence string wire.

When a motion occurs on the string wire it causes the motion detector to move, the gyro sensor sense those movements and notify them to the control center, with this data the system can know when a breach has made on the fence.

### SUMMARY OF THE INVENTION

The present invention relates to smart motion detector for electronic fence that uses the gyro sensor technology.

When the motion detector moves the gyro sensor measures the angular velocity of the movement.

According to the present invention the motion detector detects motion by a gyro sensor that placed inside of it, the detector installs on moving system inside the detectors pole which enable it to move when a motion occurs on its attaches string wire.

When the detector is moving the gyro sensor sends its measurement data to the fence control system which uses it to detect what kind of breach has made on the fence.

### BRIEF DESCRIPTION OF THE DRAWINGS

The present invention will be fully described in FIG. 1.

These figures are the embodiments of several forms of the present invention with no intention to reduce the embodiment's extent.

The present invention may be better understood in conjunction with the following FIGURE:

FIG. 1 illustrates an isometric schema of the motion detector when it construct on the sensors pole.

### DETAILED DESCRIPTION OF THE PREFERRED EMBODIMENT

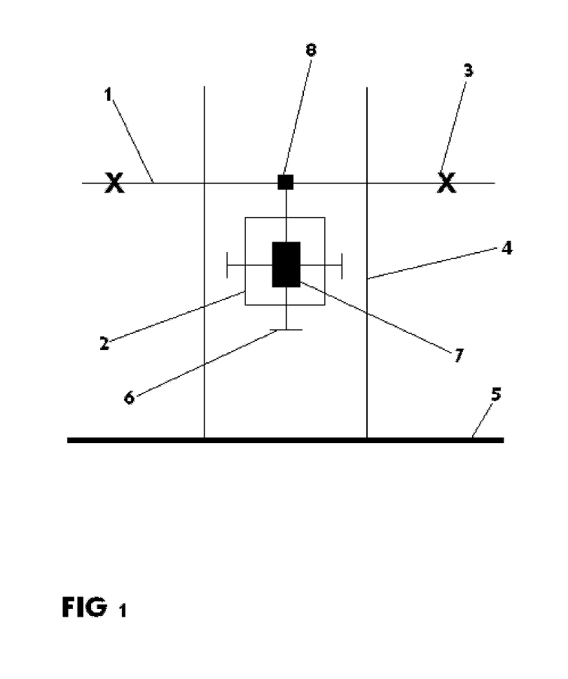

FIG. 1 illustrates an isometric schema of the motion detector when it construct on the sensors pole.

Ground (5), connector between the string wire and motion detector (8), gyro sensor (7), movement system (6), String wire (1), motion detector (2), wire spike(3), sensor pole (4).

While certain features of the invention have been illustrated and described herein, the invention can be embodied in other forms, ways, modifications, substitutions, changes, equivalents, and so forth.

The foregoing description of the embodiments of the invention has been presented for the purposes of illustration and description.

It is not intended to be exhaustive or to limit the invention to the precise form disclosed.

Many modifications and variations are possible in light of this disclosure.

It is intended that the scope of the invention be limited not by this detailed description, but rather by the claims appended hereto.

What is claimed is:

1. A smart motion detector for electronic fence can sense when motion occurs on its attaches fence string wire by using the gyro sensor technology.

2. According to claim 1, the gyro sensor measures the angular velocity of the movement.

3. According to claim 1, the smart motion detector detects motion by a gyro sensor that placed inside of it, the detector installs on a moving system inside the detectors pole which enable it to move when a motion occurs on its attaches string wire.

4. When the detector is moving the gyro sensor sends its moving angle to the fence control system which use it to detect what kind of breach has made on the wire.
